(19) United States
(12) Patent Application Publication
(10) Pub. No.: US 2018/0163896 A1
(43) Pub. Date: Jun. 14, 2018

(54) METHOD FOR DETERMINING A STATE VARIABLE OF A VALVE DIAPHRAGM OF AN ELECTRONICALLY CONTROLLED AND MOTOR-DRIVEN DIAPHRAGM VALVE, AND DIAPHRAGM VALVE SYSTEM

(71) Applicant: GEMÜ GEBR. MÜLLER APPARATEBAU GMBH & CO., KOMMANDITGESELLSCHAFT, INGELFINGEN (DE)

(72) Inventors: Gert Mueller, Kuenzelsau (DE); Joachim Brien, Boehmenkirch (DE); Werner Floegel, Doerzbach (DE)

(73) Assignee: GEMÜ GEBR. MÜLLER APPARATEBAU GMBH & CO., KOMMANDI TGESELLSCHAFT, INGELFINGEN (DE)

(21) Appl. No.: 15/579,551

(22) PCT Filed: May 17, 2016
(86) PCT No.: PCT/EP2016/060968

§ 371 Date: Dec. 4, 2017

(30) Foreign Application Priority Data
Jun. 2, 2015 (DE) 10 2015 210 208.4

(51) Int. Cl. F16K 37/00; F16K 7/00; G05B 13/02

(52) U.S. Cl. CPC F16K 37/0083; G05B 13/026; F16K 37/0091; F16K 7/00

(57) ABSTRACT

A method for determining a state variable of a valve diaphragm of a motor-driven diaphragm valve includes the following steps: a) in a first time range: moving the valve diaphragm in such a way that the diaphragm valve changes from a first state into a second state; in the process b) detecting at least one reference value of a variable which is associated with the movement process of the valve diaphragm; c) in a second time range: moving the valve diaphragm in such the way that the diaphragm valve changes from the first state into the second state; in the process d) detecting at least one operating value of the variable which is associated with the movement process of the valve diaphragm; e) comparing the at least one reference value with the at least one operating value or variables acquired therefrom; and f) determining the state variable from the result of the comparison.

The invention relates to a method for determining a state variable of a valve diaphragm of an electronically controlled and motor-driven, in particular electric or pneumatic motor-driven, diaphragm valve according to the preamble of claim 1, and to a diaphragm valve system according to the preamble of the coordinated claim.

Diaphragm valves are well known and are used to control the quantity of a fluid in a fluid flow. In a known diaphragm valve of this kind (DE 10 2012 222 062 A1), a valve diaphragm is actuated in a motorized manner, specifically pneumatically, by a valve drive. In the closed state of the diaphragm valve, the valve drive pushes the valve diaphragm onto a sealing ridge of a valve body. It is furthermore known to regularly service a valve diaphragm of this kind and to measure a state variable of the valve diaphragm, specifically the current thickness thereof, by hand during a service of this kind.

Proceeding herefrom, the object of the present invention is that of providing a method of the type mentioned at the outset, by means of which a state variable of the valve diaphragm of an electronically controlled and motor-driven, in particular electric or pneumatic motor-driven, diaphragm valve can be easily and reliably determined.

This object is achieved by a method having the features of claim 1, and by a diaphragm valve system having the features of the coordinated claim. Advantageous developments of the invention are specified in dependent claims. Furthermore, features important to the invention are found in the following description and in the accompanying drawings. In this case, the features can be important to the invention both individually and in different combinations, without further additional reference being made hereto.

According to the invention, during a first time range, a reference or initial state of the valve diaphragm is detected by a reference or initial value of a variable which is associated with a movement of the valve diaphragm being detected during a movement of the valve diaphragm, the diaphragm valve being brought from a first state into a second state by the movement. Then, during a following time range, the valve diaphragm is moved again, either in a planned manner or at random, such that the diaphragm valve is brought into the second state and the value, referred to here as the “operating value”, of the variable which is associated with the movement process of the valve diaphragm is again detected during this movement.

At least two values, specifically a reference value from a reference state and an operating value from an operating state that is temporally after the reference state, are now available. Said values can now be compared with one another, and the current state variable can then be determined from the comparison. In this case, the current state variable can either be an absolute value, which presupposes that an absolute reference value is known from the reference state, or the current state variable is a relative value, for example in the sense of a percentage or absolute change.

The method according to the invention can be carried out in a fully automatic manner, either on demand or at random, when it has been identified, during operation of the diaphragm valve, that the diaphragm valve is being brought or has been brought into the second state. This makes it possible to determine the state variable of the valve diaphragm not only during a service, during which the diaphragm valve is disassembled, but instead much more often and also during entirely normal operation of the diaphragm valve, which significantly increases the reliability of the operation of the diaphragm valve. A critical state of the valve diaphragm can also be reliably identified, even outside of regular services.

A first development of the method according to the invention is characterized in that the first time range comes immediately after a start-up or a service, and the second time range comes thereafter, during operation of the diaphragm valve. Immediately after a start-up or a service, the state variable of the valve diaphragm is in any case known, and it is therefore possible, using the method according to the invention, to detect a change in the state variable relative to a definitely known starting state. The information provided by the method according to the invention is therefore particularly sound.

It is furthermore proposed for the state variable to be a diaphragm thickness. This is a state variable that is particularly meaningful for the state of the valve diaphragm.

It is also possible for the diaphragm valve to be open, preferably maximally open, in the first state. This is a state of the diaphragm valve that is discrete and therefore particularly easy to detect.

It is furthermore possible for the diaphragm valve to be closed in the second state. This is also a discrete, and therefore particularly easily detectable, state of the diaphragm valve, and the method according to the invention is particularly precise when said state is used.

An embodiment of the method according to the invention that is particularly easy to implement in terms of data acquisition is characterized in that, in order to determine the variable which is associated with the movement process of the valve diaphragm, a plurality at least of value pairs of the position of a drive element of a valve drive and time are detected.

The variable which is associated with the movement process of the valve diaphragm can be a variable from the following group: average speed of the valve drive; final speed of the valve drive; speed profile of the valve drive; time for the movement of the valve drive from the first state of the diaphragm valve into the second state; a control deviation of the valve drive; a control parameter of the valve drive; in the case of power control: a position of a valve drive when a desired power value has been reached; in the case of position control: a power of the valve drive when a desired position value has been reached.

The precision of the method according to the invention is increased when a temperature-related and/or pressure-related influence on the variable which is associated with the movement process of the valve diaphragm is taken into account when determining the state variable.

In another development of the method according to the invention, it is proposed for the values detected during the second time period to be stored only if they deviate by more than a limit value from previously detected values. This significantly reduces the amount of data that are stored, thus saving storage space.

The fact that the determined state variable is compared with a limit value and an action is triggered depending on the result of the comparison, further increases the operational reliability of the diaphragm valve, since it is no longer necessary to “manually” check the determined state variable. This is also the case when the method is carried out during a plurality of second passages of time, and a progression of the determined state variable is determined, and when an action is triggered depending on the determined progression. In this case, checking or evaluating the progression of the state variable makes it possible to particularly reliably predict a critical state of the valve diaphragm.

It is also proposed for the action to also be dependent on a variable that characterizes the valve diaphragm, in particular a material of the valve diaphragm. This further improves the soundness of the determination result of the method according to the invention.

If the determination device and/or a storage device for the detected values is/are remote from the diaphragm valve in a diaphragm valve system, installation space is saved in the diaphragm valve and the diaphragm valve itself can be comparatively inexpensive. For example, the diaphragm valve can be in the possession of the operator, whereas the determination device and the storage device can be in the possession of the manufacturer of the diaphragm valve for example. This reduces the outlay for the operator of the diaphragm valve.

If, in contrast, the determination device and/or a storage device for the detected values is/are integrated in the diaphragm valve in a diaphragm valve system, this has the advantage that an integrated and self-monitoring unit is produced. A specific infrastructure for monitoring the diaphragm valve is not required. It is also conceivable that primarily static data are stored in the diaphragm valve, whereas primarily dynamic data are stored in a remote storage device.

A possible embodiment of the invention will be described by way of example in the following, with reference to the following drawings, in which:

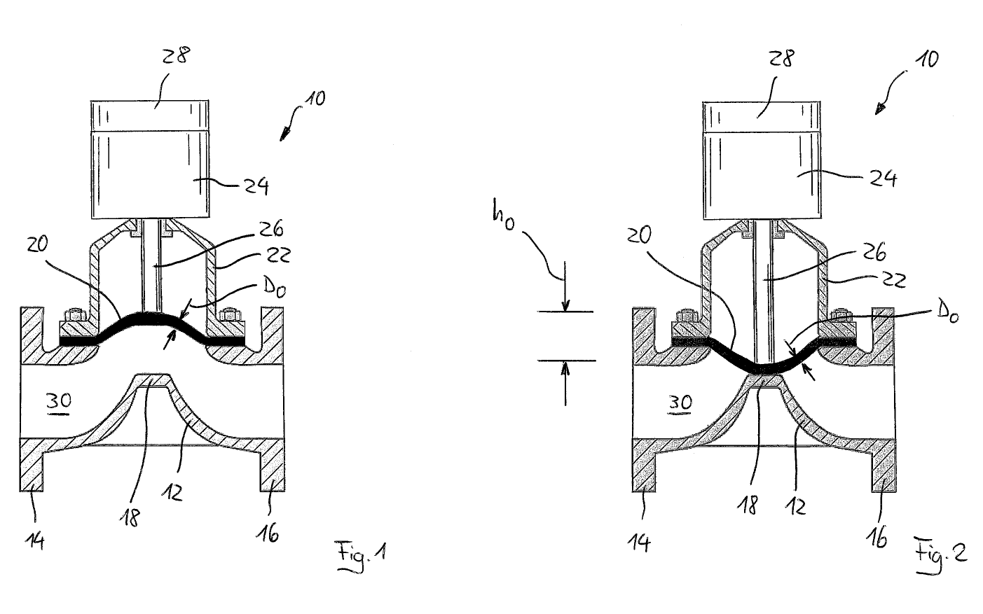

FIG. 1 is a schematic cross section through a diaphragm valve in the new and open state;

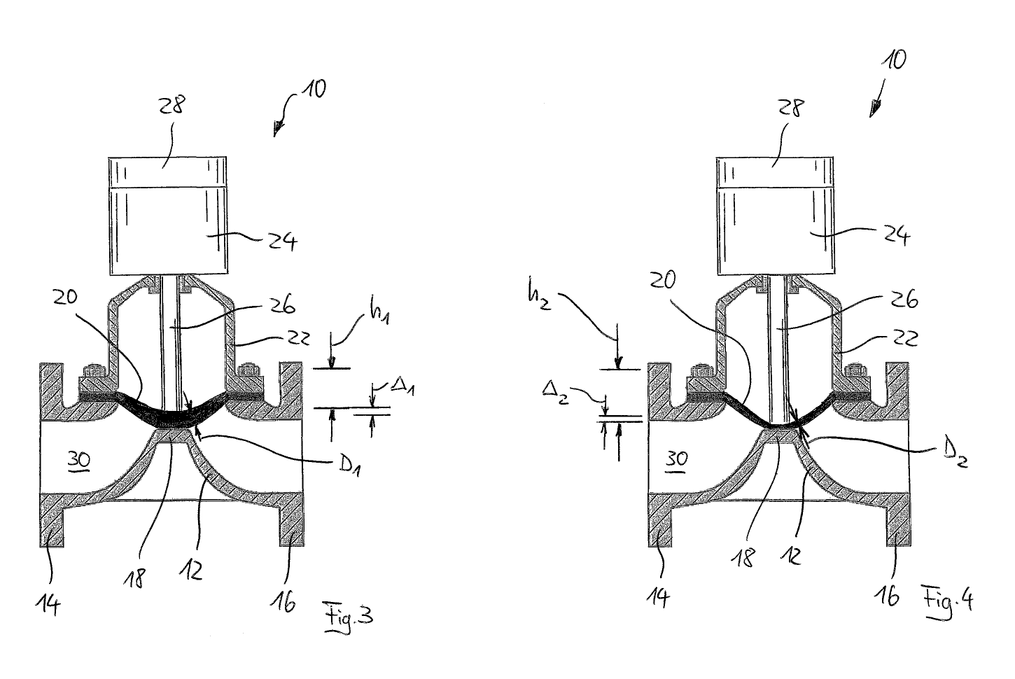

FIG. 2 shows the diaphragm valve from FIG. 1 in the closed state;

FIG. 3 is a view similar to FIG. 2, in which the diaphragm valve has a swollen valve diaphragm;

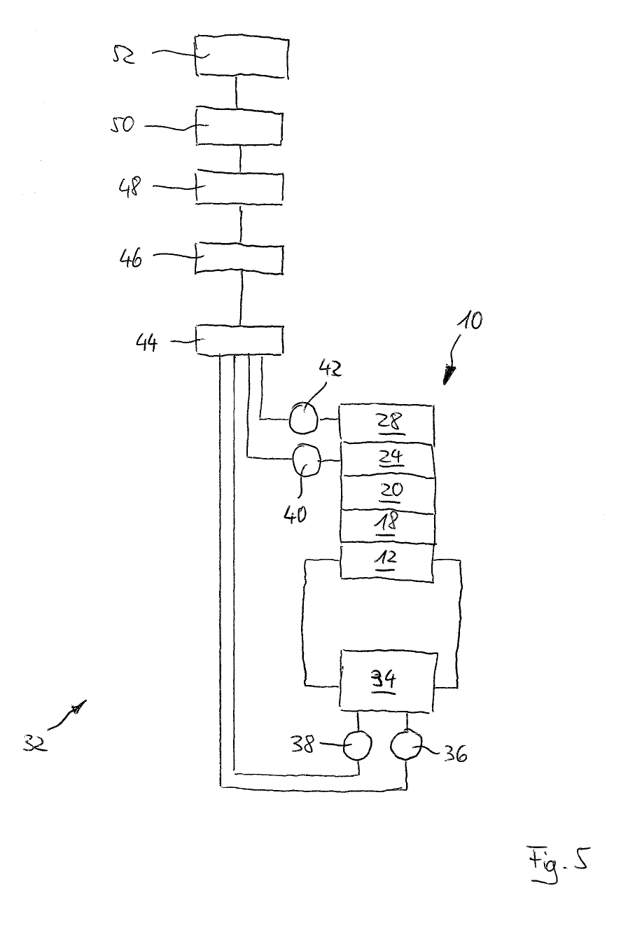

FIG. 4 is a view similar to FIG. 2, in which the diaphragm valve has a contracted valve diaphragm;

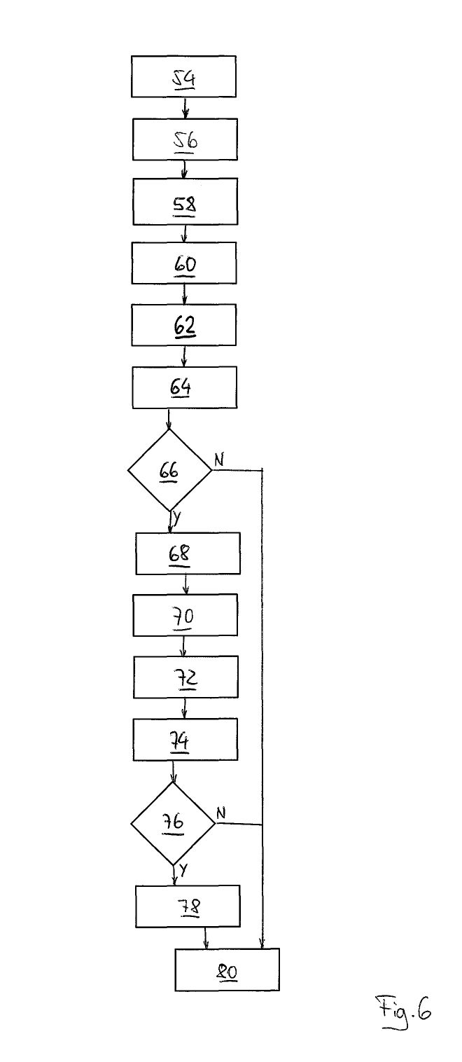

FIG. 5 is a schematic view of a diaphragm valve system; and

FIG. 6 is a flow diagram of a method for determining a state variable of the valve diaphragm of the diaphragm valve of FIGS. 1 to 4.

In FIG. 1, a diaphragm valve is denoted as a whole by reference sign 10. Said valve comprises a valve body 12 having an inlet connecting piece 14 and an outlet connecting piece 16. A ridge-like valve seat 18 is formed therebetween. The diaphragm valve 10 further comprises a domed valve diaphragm 20 that is clamped between the valve body 12 and an intermediate piece 22. A valve drive 24 is fastened to the intermediate piece 22 and comprises a drive element in the form of a drive rod 26 that is coupled to the valve diaphragm 20. In this way, the valve diaphragm 20 can be moved in a motorized manner. The valve drive 24 may be a pneumatic valve drive for example, but an electromotive valve drive is also possible. An electronic controller 28 that is arranged directly on the valve drive 24, and is integrated in the diaphragm valve 10 in this respect, is used for controlling the valve drive 24.

FIG. 1 shows the valve diaphragm 20 in a new state, in which said diaphragm has a uniform and normal thickness D₀. Furthermore, FIG. 1 shows the diaphragm valve 10 in a first state in which it is maximally open. A flow path in a flow channel 30 from the inlet connecting piece 14 to the outlet connecting piece 16 is thus open.

FIG. 2 shows the diaphragm valve 10 in a second state, in which said valve is closed by the valve diaphragm 20 having been moved against the valve seat 18, by means of the valve drive 24 and the drive rod 26. In this second state, the flow channel 30 from the inlet connecting piece 14 to the outlet connecting piece 16 is thus blocked. The path that the drive rod 26 has to travel from the first state shown in FIG. 1 to the second state shown in FIG. 2 is h₀ in the present case.

FIG. 3 again shows the diaphragm valve 10 in the second, closed state. However, the valve diaphragm 20 is not shown in the new state, but after a certain operating time. During said operating time, said diaphragm has swollen due to the operation of the diaphragm valve 10. Said valve diaphragm now has an increased thickness D₁. In order to bring the diaphragm valve 10 from the first, open state (FIG. 1) into the second, closed state, the valve drive 24 or the drive rod 26 has to travel a path h₁, the path h₁ being shorter than the path h₀ from FIG. 2 by a difference value Δ₁.

FIG. 4 again shows the diaphragm valve 10 in the second, closed state. Once again, the valve diaphragm 20 is not in the new state, but instead after a certain operating time in which it has become thinner, for example due to flexing or abrasion during operation of the diaphragm valve 10. Said valve diaphragm now has a reduced thickness D₂. In order to bring the diaphragm valve 10 from the first, open state (FIG. 1) into the second, closed state, the valve drive 24 or the drive rod 26 has to travel a path h₂, the path h₂ being longer than the path h₀ from FIG. 2 by a difference value Δ₂.

As will be explained in detail below, this situation is made use of in order to determine a state variable, in the form of the thickness D of the valve diaphragm 20, during operation of the diaphragm valve 10. The diaphragm valve system 32 shown schematically in FIG. 5 is used for this purpose:

Said system comprises the diaphragm valve 10 shown in FIGS. 1 to 4, which is installed in a technical facility 34 that is shown schematically merely by a box in the present case. The technical facility 34 comprises, inter alia, two sensors 36 and 38 that detect a temperature and a pressure P of the fluid flowing through the diaphragm valve 10. The valve drive 24 is connected to a position sensor 40 that detects the current position of the drive rod 26. In this case, the position sensor 40 does not necessarily need to be a separate sensor, but instead can be integrated, as a function, in the control software of the valve drive 24. A time stamp is also provided by the electronic controller 28, and this is indicated by reference sign 42. A time stamp of this kind is not vital, however.

The temperature sensor 36, the pressure sensor 38, the position sensor 40 and the time stamp provision 42 are connected to an interface 44 that communicates with an interface 46 remote therefrom. The term “remote” means that said interface 46 is not arranged directly on the diaphragm valve 10, but instead at another point with the operator of the technical facility 34 or even not with the operator at all, but instead at an entirely different location, for example with the manufacturer of the diaphragm valve 10 or another service provider.

The interface 46 is connected to a storage means 48 (“IoT cloud”) that leads, via a filter 50, to a determination device 52. The storage means 48, the filter 50 and the determination device 52 are therefore also remote from the diaphragm valve 10. In an embodiment that is not shown, the elements 44 to 52, or at least some of said elements, are not remote from the diaphragm valve 10 but instead are integrated therein, for example by being arranged in the electronic controller 28.

A method for determining a state variable in the form of the thickness D or a change Δ in the thickness D of the valve diaphragm 20 will now be explained with reference to FIG. 6. The method is stored at least in part as a computer program on a storage means of the determination device 52.

Following a starting block 54, an initialization cycle for the diaphragm valve 10 is begun in a block 56. This initialization cycle 56 takes place in a “first time range” of the life of the diaphragm valve 10, specifically immediately after the installation thereof in the technical facility 34, when the valve diaphragm 20 is still completely new and unused. Alternatively, said initialization cycle 56 can also be carried out after a service of the diaphragm valve 10, in which the valve diaphragm 20 has been replaced, and the installed valve diaphragm 20 is thus in the new state.

In this initialization cycle 56, the valve drive 24 is controlled such that the diaphragm valve 10 is in the first, open state (FIG. 1) thereof. The valve drive 24 is then controlled such that the diaphragm valve 10 changes from the first, open state into the second, closed state (FIG. 2). During the initialization cycle 56, corresponding values are detected by the temperature sensor 36, the pressure sensor 38, the position sensor 40 and the time stamp provision 42 (block 58) and are supplied, via the interfaces 44 and 46, to the storage means 48 and stored therein (block 60). The stored values are therefore quadruple values.

In the embodiment specifically described here, the second, closed state of the diaphragm valve 10 is identified by power control. For this purpose, the thrust acting on the drive rod 26 is detected at least indirectly, for example via the input current required for actuation, in the valve drive 24 in the form of an actual power value. If said actual power value reaches a limit value (desired power value), it is assumed that the valve diaphragm 20 is sufficiently firmly pressed against the valve seat 18 and that the diaphragm valve 10 is thus in the closed, second state. The valve drive 44 is then stopped by the electronic controller 28.

The corresponding position of the drive rod 26 that has been reached and has been transmitted by the position sensor 40 reveals the lift h₀ in a new and unused valve diaphragm 20 (FIG. 2). The position of the drive rod 26, which is part of the valve drive 24, when the desired power value has been reached, which position is detected in 58 and stored in 60 as the “reference or initial value”, can therefore be said to be a variable which is associated with the movement process of the valve diaphragm 20, specifically the end of the movement process.

The diaphragm valve 10 or the diaphragm valve system 32 is now operated entirely normally, in conventional operation of the technical facility 34 (block 62), in that the valve drive 24 is controlled by the electronic controller 28 in accordance with the requirements of the technical facility 34. In this case, the values mentioned above are detected continuously (block 64). In a comparison block 66, a check is carried out as to whether the detected values differ from the values detected at an earlier time. Only if this is the case are the newly detected values or quadruple values stored, permanently or temporarily, in the storage means 48 as raw data in block 68.

In the process, during random time ranges (“second time ranges”), it is often the case that the diaphragm valve 10 changes into the closed, second state on account of movement of the valve diaphragm 20. Closure of the diaphragm valve 10 is in turn identified from a detected actual power reaching a specified desired power or, for example, when an actual position value reaches a desired position value of the closed diaphragm valve 10. Whenever closure has been identified, the corresponding position value is compared, as what is known as the “operating value”, with the reference value detected and stored during the initialization process in block 56. If no other influences have acted on the valve diaphragm 20, the ascertained difference should correspond to a change Δ in the thickness of the valve diaphragm 20.

In reality, however, the above-mentioned operating value of the position of the drive rod 26 is also influenced by factors that are unrelated to the thickness D of the valve diaphragm 20. For example, a high pressure in the flow channel 30 can influence the position of the drive rod 26, as can a high temperature of the fluid flowing in the flow channel 30, which results in overall heating of the diaphragm valve 10. Therefore, the values provided by the pressure sensor 38 and the temperature sensor 36 are used in block 72 to accordingly correct the difference determined in 70. This can also be referred to as “filtering”, since the influences of pressure and temperature are filtered out from the determined value, and this is carried out in the filter 50 in the diaphragm valve system 32 shown in FIG. 5.

The filtered difference value thus obtained reveals, in block 74, the actual change Δ₁ or Δ₂ in the thickness D of the valve diaphragm 20 (see FIGS. 3 and 4). If the current thickness D₁ is greater than the thickness D₀ determined during the initialization cycle in block 56, this means that the valve diaphragm 20 has swollen, for example due to thermal influences, by the value Δ₁. If the current thickness D₂ is less than the thickness D₀ determined during the initialization cycle in block 56, this means that the valve diaphragm 20 has thinned, for example due to abrasion and/or flexing, by the value Δ₂.

In block 76, the ascertained actual change Δ₁ or Δ₂ is compared with a limit value. If the change Δ₁ or Δ₂ is greater than the limit value, an alarm is triggered in 78. The method ends in block 80. The steps of blocks 70 to 78 are carried out in the determination device 52 of FIG. 5. In the explanation of the method, a position value for the drive rod 26 has been used, above, as the variable which is associated with the movement process of the valve diaphragm 20. It is in principle also conceivable, however, to use the following other variables: average speed of the valve drive; final speed of the valve drive; speed profile of the valve drive; time for the movement of the valve drive from the first state of the diaphragm valve into the second state; a control deviation of the valve drive; a control parameter of the valve drive; in the case of position control: a power of the valve drive when a desired position value has been reached.

For example, in the case of a swollen valve diaphragm, when the valve drive attempts, upon closure of the diaphragm valve, to force the valve diaphragm into the position detected during the initialization, the speed of the valve drive is lower until the very end because the valve diaphragm has to be squeezed, as it were, by the valve drive. In the case of a thinned diaphragm, said diaphragm will have a higher speed overall during a movement than during the initialization cycle, since a thinner valve diaphragm offers less resistance.

The variables mentioned above would then be detected in steps 58 and 64 of FIG. 6, and stored in steps 60 and 68, and a conclusion regarding the state of the valve diaphragm 20 would then be drawn from the comparison of the reference values with the operating values. It is also possible for one of these variables to be used to carry out a plausibility check of another of these variables.

In an embodiment that is not shown and explained, the temporal progression of the thickness of the valve diaphragm is additionally stored and evaluated. An evaluation of this kind makes it possible to predict a service requirement or a time at which damage to or rupture of the valve diaphragm will occur.

In another embodiment that is not shown and explained, in addition a variable which characterizes the valve diaphragm, for example a material of the valve diaphragm, can also be taken into account when evaluating the current thickness of the valve diaphragm and/or when evaluating the temporal progression of the thickness of the valve diaphragm. The actual material of the valve diaphragm plays a role in particular in the prediction of possible damage to or rupture of the valve diaphragm. The determination device identifies the variable which characterizes the valve diaphragm for example from data that are read out from a storage means that is connected to the valve diaphragm or integrated therein and that can be read remotely, for example an RFID chip.

What is claimed is:

1. Method for determining a state variable of a valve diaphragm of a motor-driven diaphragm valve, characterized in that said method comprises the following steps:
a. in a first time range: moving the valve diaphragm in such a way that the diaphragm valve changes from a first state into a second state; in the process
b. detecting at least one reference value of a variable which is associated with the movement process of the valve diaphragm;
c. in a second time range: moving the valve diaphragm in such a way that the diaphragm valve changes from the first state into the second state; in the process
d. detecting at least one operating value of the variable which is associated with the movement process of the valve diaphragm;
e. comparing the at least one reference value with the at least one operating value or variables acquired therefrom; and
f. determining the state variable from the result of the comparison.

2. Method according to claim 1, characterized in that the first time range is immediately after a start-up or a service, and the second time range is thereafter, during operation of the diaphragm valve.

3. Method according to claim 1, characterized in that the state variable is a diaphragm thickness or a change in the diaphragm thickness.

4. Method according to claim 1, characterized in that the diaphragm valve is open, preferably maximally open, in the first state.

5. Method according to claim 1, characterized in that the diaphragm valve is closed in the second state.

6. Method according to claim 1, characterized in that, in order to determine the variable which is associated with the movement process of the valve diaphragm, a plurality of value pairs of the position of a drive element of a valve drive or of an equivalent variable and time are detected.

7. Method according to claim 1, characterized in that the variable which is associated with the movement process of the valve diaphragm is a variable from the following group: average speed of the valve drive; final speed of the valve drive speed profile of the valve drive time for the movement of the valve drive from the first state of the diaphragm valve into the second state; a control deviation of the valve drive; a control parameter of the valve drive; in the case of power control: a position of a valve drive when a desired power value has been reached; in the case of position control: a power of the valve drive when a desired position value has been reached.

8. Method according to claim 1, characterized in that a temperature-related and/or pressure-related influence on the variable which is associated with the movement process of the valve diaphragm is taken into account when determining the state variable.

9. Method according to claim 1, characterized in that the values detected during the second time period are stored only if they deviate by more than a limit value from previously detected values.

10. Method according to claim 1, characterized in that the determined state variable is compared with a limit value and an action is triggered depending on the result of the comparison.

11. Method according to claim 1, characterized in that it is carried out during a plurality of second passages of time, and a progression of the determined state variable is determined, and in that an action is triggered depending on the determined progression.

12. Method according to claim 1, characterized in that the action is also dependent on a variable that characterizes the valve diaphragm, in particular a material of the valve diaphragm.

13. Diaphragm valve system, comprising a valve body, a valve diaphragm, a valve drive that is coupled to the valve diaphragm by means of a drive element, and an electronic controller for controlling the valve drive, characterized in that said system further comprises: a detection device which detects values of at least one variable which is associated with the movement of the valve diaphragm, and a determination device for determining a state variable of the valve diaphragm from the detected values, the diaphragm valve system being set up and programmed to carry out a method comprising the steps of
a. in a first time range: moving the valve diaphragm in such a way that the diaphragm valve changes from a first state into a second state; in the process
b. detecting at least one reference value of a variable which is associated with the movement process of the valve diaphragm;
c. in a second time range: moving the valve diaphragm in such a way that the diaphragm valve changes from the first state into the second state; in the process
d. detecting at least one operating value of the variable which is associated with the movement process of the valve diaphragm;
e. comparing the at least one reference value with the at least one operating value or variables acquired therefrom; and
f. determining the state variable from the result of the comparison.

14. Diaphragm valve system according to claim 13, characterized in that at last one of the determination device and a storage device for the detected values is arranged remote from the diaphragm valve.

15. Diaphragm valve system according to claim 13, characterized in that at least one of the determination device and a storage device for the detected values is integrated in the diaphragm valve.
